(19) United States
(12) Patent Application Publication
(10) Pub. No.: US 2010/0005743 A1
(43) Pub. Date: Jan. 14, 2010

(54) Flexible Cement Veneer

(76) Inventor: Jay L. Anderson, Grantsville, UT (US)

Correspondence Address: Floris Chad Copier, 5373 W. 10480 N., Highland, UT, 84003, US

(21) Appl. No.: 12/172,212

(22) Filed: Jul. 11, 2008

(51) Int. Cl. B44F 9/04

(52) U.S. Cl. 52/314; 52/309.13

(57) ABSTRACT

A surface veneer for simulating the appearance of stone, tile, concrete, leather, wood, stucco, etc. is disclosed. The veneer may be made by producing a mold of a desired texture, filling the mold with a mixture including portland-type cement, resin, and colorant, with the mixture being impregnated with a support mesh. The veneer may be made to have an average thickness between about 1/16 and ¼ inches in a sheet form. When produced, the veneer is flexible, being able to conform to various surfaces and applied to various surfaces using any of various adhesives, and able to be transported is a finished form to an installation site. The veneer may also be finished prior to installation with a wide range of surface finishes and textures.

### FIELD

This application relates generally to durable building materials. More particularly, this application relates to flexible cement-based veneer or sheet material for application on a variety of surfaces to provide decorative and protective finished surfaces.

### BACKGROUND

Concrete surfaces, particularly concrete surfaces used in high-traffic and exterior locations, can crack and otherwise break-down over time. Removing and replacing damaged concrete surfaces can be very expensive and time consuming, and may not be appropriate for all situations. Concrete sealers and other coating products may provide some protection, but the underlying damage and texture of the concrete remains. Similarly, stucco and other cement-based products may also encounter similar problems over time.

Some concrete repair solutions include covering the concrete with tile, pavers, or other ceramic or rock products to hide damaged concrete. However, such products may be expensive and time consuming, requiring skilled individuals to install the products. Additionally, tile, pavers, and other stone products are stiff and brittle and tend to crack if any imperfections in the underlying concrete exist, particularly when resurfacing concrete outdoors like patios, porches, sidewalks, driveways, etc.

### SUMMARY

A surface veneer for simulating the appearance of stone, tile, concrete, leather, wood, stucco, etc. is disclosed. The veneer may be made by producing a mold of a desired texture, filling the mold with a mixture including portland-type cement, resin, and colorant, with the mixture being impregnated with a support mesh. The veneer may be made to have an average thickness between about 1/16 and ¼ inches in a sheet form. Sheets of veneer may be made in a variety of sizes, such as 4′×4′ and 4′×8′ sheets. When produced, the veneer is flexible, being able to conform to various surfaces and applied to various surfaces using any of various adhesives, and able to be transported is a finished form to an installation site.

The veneer may be finished prior to installation with a wide range of surface finishes and textures. The veneer may be finished for a particular application, such as for exterior, heavy traffic use, or for decorative interior wall covering or tub and shower surrounds. In some embodiments, the veneer may also include a peel coat to protect the finish during transportation and installation. Thinset may be used to adhere the veneer to a desired surface. Excess thinset may be allowed to create grout lines between veneer panels and then leveled with a trowel. Excess thinset on the face of the veneer panel would then be removed when the peel coat is removed, leaving a clean surface and grout line edge.

These and other aspects of the present invention will become more fully apparent from the following description and appended claims.

### BRIEF DESCRIPTION OF THE DRAWINGS

The following description can be better understood in light of Figures, in which:

FIG. 1 is a cross-sectional view of an exemplary embodiment of a flexible cement veneer;

FIG. 2 is an elevated perspective view of an exemplary embodiment of a flexible cement veneer during formation;

FIG. 3 is a cross-sectional view of an exemplary embodiment of a flexible cement veneer during formation;

FIG. 4 is a perspective view of an exemplary embodiment of a depth gauge for use in forming flexible cement veneers;

FIG. 5 is a perspective view of an exemplary embodiment of a mold for use in forming flexible cement veneers;

FIG. 6 is flow diagram of an exemplary method of manufacturing a flexible cement veneer; and

FIG. 7 is a flow diagram of an exemplary method of installing a flexible cement veneer.

Together with the following description, the Figures demonstrate and explain the principles of flexible cement veneers and associated methods. In the Figures, the thickness of layers and regions may be exaggerated for clarity. The same reference numerals in different drawings represent the same element, and thus their descriptions may not be repeated.

### DETAILED DESCRIPTION

In the illustrated embodiments, aspects and features of flexible cement veneer products and associated methods are disclosed and described below. The following description supplies specific details in order to provide a thorough understanding. Nevertheless, the skilled artisan would understand that the apparatus and associated methods of using the apparatus can be implemented and used without employing these specific details. Indeed, the devices and associated methods can be placed into practice by modifying the illustrated devices and associated methods and can be used in conjunction with any other apparatus and techniques conventionally used in the industry.

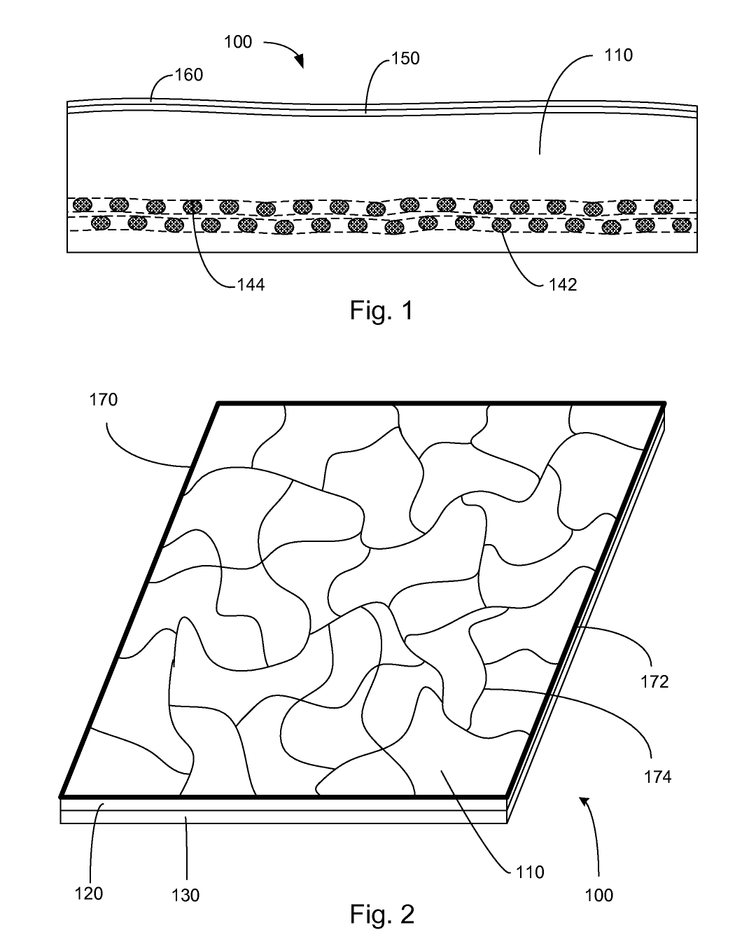

Exemplary flexible cement veneers that may be formed using the methods described herein are illustrated in FIG. 1. FIG. 1 illustrates a cross-sectional view of an exemplary flexible cement veneer 100, which may include base 110, mesh layers 142, 144, finish layer 150, and peel layer 160. In FIG. 1 the dimensions of flexible cement veneer 100 and its various components and layers are exaggerated for illustrative purposes.

Body 110 may be a cement-based mixture formed as described below, and made of a mixture of water-based epoxy, resin, water, colorants or pigments, sand, and cement. In some embodiments, the epoxy may be provided to the mixture as a separate resin and catalyst, such as those offered by Tresco Paint in Hayward, Calif. Similarly, the resin may be Astro 600 resin also offered by Tresco Paint. The sand may be dolomite sand, such as Dolowhite sand offered by Chemical Lime of Salinas, Calif., and the cement may be portland, white, type I or II, or any mixture thereof to achieve a desired color along with colorants, which may be any colorants used in producing colored cement products. For example, in some embodiments the quantity of cement in the mixture may be apportioned between white and grey portland-type cements depending on the desired final color, or shading to enhance selected colorants.

The proportion of the various materials in the mixture of base 110, may vary, depending on the desired hardness, durability, flexibility, veneer thickness, color, shade, or other desired characteristics. In some embodiments, for example, the cement may be between about 5 and about 10 lbs., the Astro 600 resin may be between about 12 and 72 oz., the sand may be total between about 15 and 50 lbs, with any combination of dolomite, or other similar sand products, and the epoxy amounts may vary. Of course the amount of water added may be adjusted depending on desired thickness and workability of the mixture. In some exemplary embodiments, the proportions of the various components by volume of the mixture may be about the following amounts:

32 oz. epoxy part A from Tresco Paints;

16 oz. epoxy part B from Tresco Paints;

36 oz. Astro 600 resin from Tresco Paints;

70 oz. water;

colorants as desired;

22 lbs. dolowhite #70 sand from Chemical Lime;

9 lbs. dolowhite #100 sand from Chemical Lime; and

7.85 lbs cement.

The mixture above may be produced by first mixing the epoxy components, resin, and water, followed by colorants, sand and cement to create the desired mixture for producing breakable cement veneer 100. In addition to the components described above, base 110 may also include other additives in the mixture such as hardeners, UV resistant or reflective materials, low-heat materials, recycled materials such as ground concrete, plastic, glass, etc., or any other cement additive as desired by one of ordinary skill that provides a cement veneer as described. For example, ground concrete and glass, along with lime, may be substituted for some or all of the dolomite sand.

Mesh layers 142, 144 may be any mesh to provide structural support in base 110, allowing flexible cement veneer an extent of flexibility and handling beyond a veneer of cement mixture of base 110 alone. Mesh layers 142, 144 may be nylon, metal, plastics, or any other material sufficient to be embedded in flexible cement veneer 100 and provide desirable structural characteristics. In some embodiments, mesh 142, 144 may be provided such that the material of base 110 extends through mesh 142, 144 such that mesh 142, 144 is embedded within base 110. Mesh 142, 144, may be any mesh pattern, dimensions of mesh openings, or other material characteristics such as woven, glued, welded meshes as desired to provide structural support for flexible cement veneer 100.

In some embodiments, flexible cement veneer 100 may have a single mesh layer 142, or multiple mesh layers, (i.e., 3, 4, 5, etc.), depending on desired qualities of finished cement veneer 100. Similarly each of mesh layers 142, 144, or a single layer, may be located at and depth and at any spacing within base 110, and the direction of filaments of mesh 142, 144 may be set at any angle with respect to the external edges of flexible cement veneer 100.

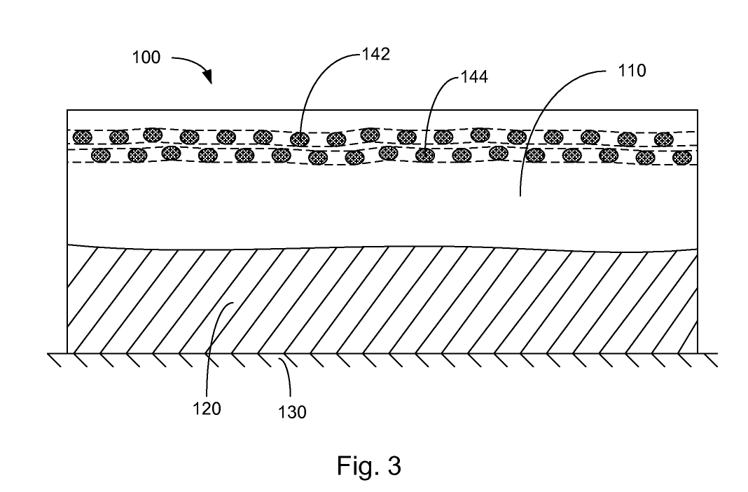

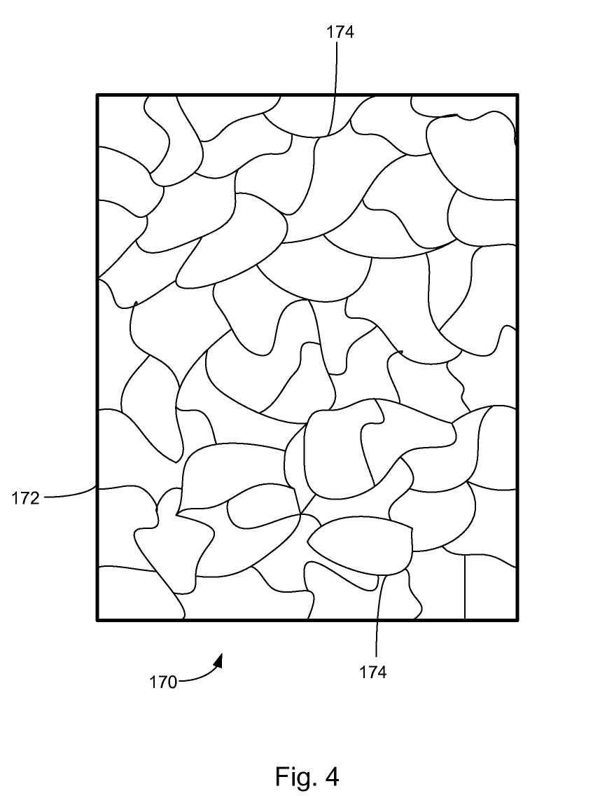

As shown in FIGS. 2 and 3, mold 120 may be placed on support surface 130. Support surface 130 may be a movable support such as a board or other stiff support material such as a table, conveyor surface, etc. that may be used to support mold 120 during manufacture of flexible cement veneer 100. Depth gauge 170 may be disposed over mold 120 during manufacture of flexible cement veneer 100 as described below.

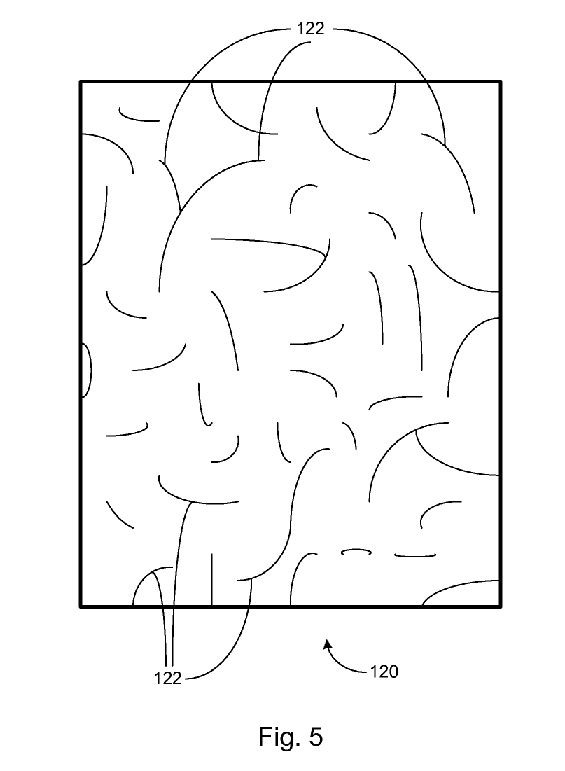

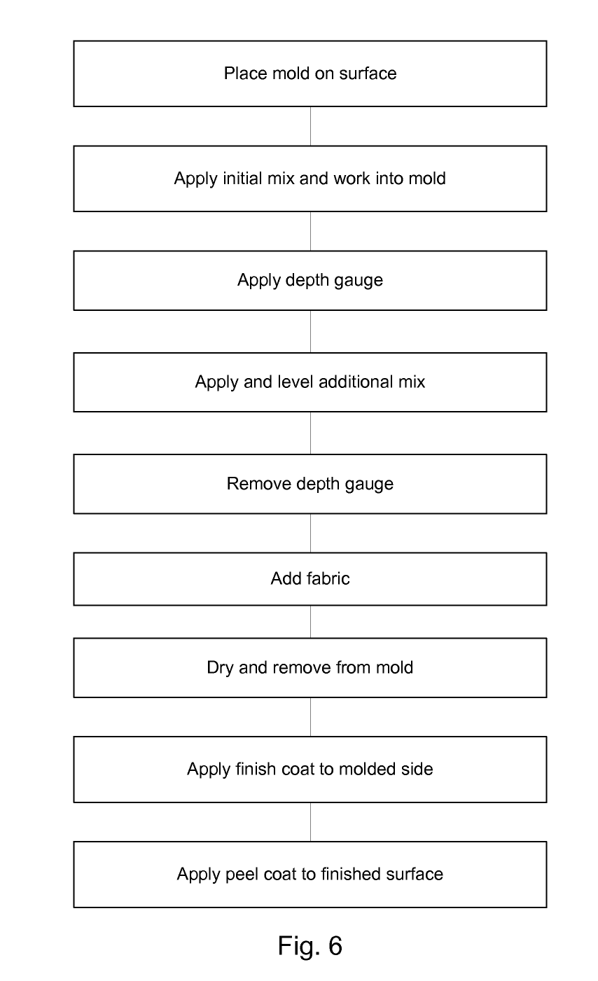

As generally illustrated in the flow-chart of FIG. 6, in some embodiments, flexible cement veneer 100 may be manufactured by providing mold 120 on support surface 130, and applying a cement mixture of base 110 to mold 120. A release agent may be applied to mold 120 prior to applying any of the cement mixture of base 110. A first amount of cement mixture may be applied to mold 120 and brushed, pressed, troweled, or otherwise forced into features 122 (see FIG. 5) of mold 120. Depth gauge 170, as shown in FIGS. 2 and 4, may then be placed over mold 120 having a first amount of mixture on the mold surface of mold 120. Sufficient mixture of base 110 may then be applied over depth gauge 170 and leveled with a trowel, float, oscillations, vibrations, or other device or process such that the thickness of base 110 approximates the thickness of gauge wires 174 to provide a generally uniform thickness.

In some embodiments, base 110 may have a generally uniform thickness generally slightly more than the thickness of gauge wires 174 of depth gauge 170. Gauge wires 174 may be random in pattern within frame 172, sufficiently spaced to provide for a generally uniform depth of base 110 without imparting a pattern into base 110 as a result of depth gauge 170. Depth gauge 170 may be selected based on the desired finished thickness of flexible cement veneer 100. Frame 172 may be stiffer than gauge wires 174 to provide sturdy frame 172 of depth gauge 170, while having the same gauge as gauge wires 174. In some embodiments, frame 172 may be coupled side-by-side layers of gauge wires to provide the framing and stiffness for depth gauge 170. Depth gauge 170, frame 172, and gauge wires 174 may be metal, plastic, or any other suitable material, or any combination of those materials.

In some embodiments, depth gauge 170 may not be needed where an automated process levels base 110, where mold 120 has upwardly extending edges that may allow screeding or leveling based on the depth of mold 120, electronic confirmation of thickness, or other mechanized or automated process or device to provide a generally uniform thickness. The thickness of flexible cement veneer 100 may be between about 1/16 and ¼ inch, as desired. In some embodiments, thicknesses of more than ¼ inch may be achieved, as desired.

Once the thickness of base 110 is established, depth gauge 170 may be removed, if used, and mesh layer 144 may be placed on base 110 and worked into base 110 with troweling or other process. This process may remove any lingering pattern from depth gauge 170 in base 110. Mesh layer 142 may then be similarly embedded into base 110. In some embodiments, mesh layer 144 may be placed on mold 120 after applying the first amount of mixture and before applying additional mixture and using depth gauge 170, with mesh layer 144 following removal of depth gauge 170 and leveling base 110.

Flexible cement veneer 100 may then be allowed to dry. Once dry, flexible cement veneer 100 may be removed from mold 120, with features 122 of mold 120 resulting in corresponding features in flexible cement veneer 100. Mold 120 may have any pattern desired in flexible cement veneer 100, such as brushed concrete, leather, brick, skip trowel, stucco, stone, sand, or virtually any desired pattern that may be molded into mold 120. Mold 120 may be made of flexible material such as rubber, foam, latex, or other mold material, or may be hard, such as metal, ceramic, or other hard molds.

After removal from mold 120, the molded surface of flexible cement veneer 100 may then be processed and/or finished using any known cement finishing process such as acid wash, stain, epoxy coating, etc., resulting in finish layer 150. Finish layer 150 may be made to virtually any color (translucent, solid, mixed, blended, etc.) and finish quality (such as waterproof, water penetrable, water vapor penetrable, gloss, satin, flat, etc. finishes). Once finish layer 150 is completed, peel layer 160 may be applied to protect finish layer 150 of flexible cement veneer 100. Peel layer 160 may be any coating, such as a brush or spray on liquid polymer coating that dries to a peelable layer, with the advantage of adhering to each surface feature 122 of finish layer 150. Similarly, other membranes or covering, such as plastic sheeting or other known coatings may be used.

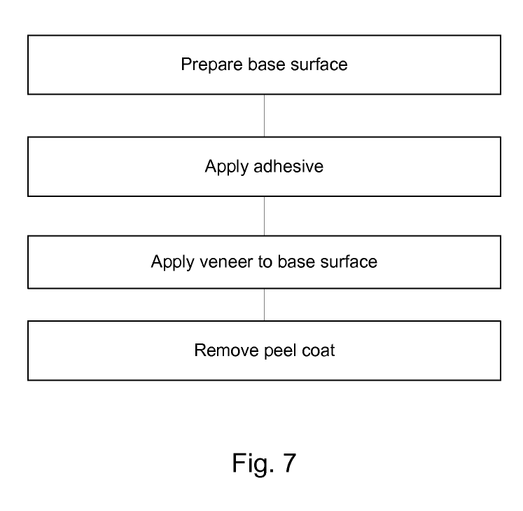

As generally shown in FIG. 7, flexible cement veneer 100 may be installed by first preparing a surface for installation of flexible cement veneer 100. Depending on the surface and the desired final appearance, preparation may include patching, grinding, cleaning, leveling, etc., the surface to be covered. The surface to be covered may be a wall, ceiling, floor, or other desired surface, and may be and exterior on interior surface. Additionally, the flexible nature of flexible cement veneer 100 may allow installation of flexible cement veneer 100 on cracked, somewhat uneven, curved, sloping, etc, surfaces. Flexible cement veneer 100 may be installed on a surface that will allow adhesive bonding of flexible cement veneer 100. Flexible cement veneer 100 may be adhered to a desired surface using any known adhesive or bonding medium, such as various thinsets, glues, etc., used to adhere building materials to each other

Once flexible cement veneer 100 is applied and in place, peel coat 160 may be removed to reveal finished layer 150. Peel coat 160 may provide ease of installation because installers need not worry about cleaning excess adhesives or materials from the presented surface of flexible cement veneer 100 because any materials deposited on the presented surface may be removed along with peel coat 160. Similarly, peel coat 160 may provide protection from dirt, scratches, or other damage prior to and during the installation process.

In some embodiments, flexible cement veneer 100 may be manufactured in sheets of material with any desired dimension, depending on the size of mold 120 and a desired finished dimension. For example, flexible cement veneer 100 may be made in 4′×4′ or 4′×8′ sheets. Of course, virtually any size may be produced, limited only by the transportation and handling considerations of manufacture and subsequent installation. Similarly, mold 120 may be made in a variety of shapes and designs, such as a 90 degree angle mold for corners, stair treads, etc., undulating, corrugated, curved, or other desired contour.

In some embodiments, flexible cement veneer 100 may stiffen over time once installed, gaining strength and durability as the cement in flexible cement veneer 100 fully cures. A desired shape or contour of flexible cement veneer 100 may also be achieved by placing flexible cement veneer in a desired shape, wetting veneer 100, and allowing veneer 100 to dry while being held in the desired shape.

In some embodiments, base layer 110 maybe formed using a mix, with the dry portions of the mix being premixed and the liquid portions being provided in separate containers. For example, a kit having each of the components of the mix may be provided and assembled at the site where the veneer is to be placed. The mix may be used as the adhesive, or may be used to prepare the surface to be covered prior to covering, or may be used to cover a portion of the floor alone.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. A device, comprising:
a base layer, wherein the base layer includes a mixture of,
cement,
sand, and
epoxy; and
a first support layer, wherein the device is configured to be transported, and wherein the device is configured such that it may be installed on uneven, non-planar, and/or planar surfaces.

2. The device of claim 1, wherein the base layer further includes resin.

3. The device of claim 1, wherein at least one of the base layer and the finish layer further includes colorant.

4. The device of claim 1, wherein the first support layer is a nylon mesh.

5. The device of claim 4, wherein the first support layer is embedded within the base layer.

6. The device of claim 1, further comprising a second support layer.

7. The device of claim 1, the device has a generally uniform thickness of between about 1/16 and ¼ inches.

8. The device of claim 7, wherein the device has a generally uniform thickness of about ⅛ inch.

9. The device of claim 1, wherein the device is a sheet material that measures between about 2 inches and 12 feet wide and between about 2 inches and 12 feet long.

10. The device of claim 1, further comprising a finish layer, and a textured surface.

11. The device of claim 10, wherein the finish layer covers the textured surface.

12. The device of claim 1, wherein the finish layer includes at least one colorant and at least one binding agent.

13. The device of claim 1, further comprising a peel layer, wherein the peel layer is located on the finish layer.

14. The device of claim 13, wherein the peel layer is configured to be removed after installation of the device such that the peel coat protects the finish layer until the peel coat is removed.

15. The device of claim 1, wherein the base layer is made with at mixture made with at least the following components by weight:
between about 15-50 lbs. dolomite sand;
between about 12-72 oz. resin;
between about 32-64 oz. epoxy mix of resin and catalyst;
between about 5-10 lbs. portland cement; and
water.

16. The device of claim 15, wherein the portland cement is type I, type II, or a mixture thereof.

17. The device of claim 15, wherein the dolomite sand is #70, #100 or a mixture thereof.

18. A device, comprising:
a body made from a mix including ingredient proportioned about,
between about 15-50 lbs. dolomite sand,
between about 12-72 oz. resin,
between about 32-64 oz. epoxy mix of resin and catalyst,
between about 5-10 lbs. portland cement, and
70 oz. water; and
a finish layer on an exterior surface of the body.

19. The device of claim 18, further comprising a removable peel layer applied over the finish layer.

20. The device of claim 18, wherein the device is configured to be transported from a manufacture site to an install site.

21. The device of claim 18, wherein the dolomite sand is about 31 lbs,
the resin is about 36 oz.,
the epoxy mix is about 48 oz.,
the cement is about 7.85 lbs., and
the water is about 70 oz.

22. The device of claim 21, wherein the dolomite sand includes 22 lbs. #70 and 9 lbs. of #100.

23. The device of claim 18, wherein the cement is one or more of white and grey portland cement.

24. A mix, comprising ingredients proportioned between about:
15-50 lbs. dolomite sand;
12-72 oz. resin;
32-64 oz. epoxy mix of resin and catalyst; and
5-10 lbs. portland cement.

25. The mix of claim 24, further comprising colorant.
